(19) United States
(12) Patent Application Publication
(10) Pub. No.: US 2026/0148554 A1
(43) Pub. Date: May 28, 2026

(54) EVENT DETECTION SYSTEM WITH ADAPTIVELY CHANGEABLE EVENT DETECTION CONDITIONS

(71) Applicant: EdgeDX Co., Ltd., Seoul (KR)

(72) Inventor: Dong Uk PARK, Seoul (KR)

(73) Assignee: EdgeDX Co., Ltd., Seoul (KR)

(21) Appl. No.: 19/391,995

(22) Filed: Nov. 17, 2025

(30) Foreign Application Priority Data
Nov. 27, 2024 (KR) 10-2024-0172211

(51) Int. Cl. G06V 20/40; G06V 10/25; G06V 10/764; G06V 10/94; G06V 20/52; H04N 7/18

(52) U.S. Cl. CPC G06V 20/44; G06V 10/25; G06V 10/764; G06V 20/41; G06V 20/52; H04N 7/181; H04N 7/188; G06V 10/95; G06V 2201/10

(57) ABSTRACT

An event detection system with adaptively changeable event detection conditions according to an aspect of the present invention includes an edge device that analyzes a captured video in real time and detects a defined event on the basis of set detection conditions, and a control server that verifies an event detection result transmitted by the edge device, collects statistical information on a result of the verification, and then controls the edge device to adjust and change the detection conditions on the basis of the statistical information.

### CROSS-REFERENCE TO RELATED APPLICATION(S)

This application claims priority from Korean Patent Application No. 10-2024-0172211, filed on Nov. 27, 2024, in the Korean Intellectual Property Office, the disclosure of which is incorporated herein by reference in its entirety.

### BACKGROUND

### 1. Field

The present invention relates to a technology for detecting abnormalities in videos, and more particularly, to a technology for automatically changing detection conditions under which abnormalities are detected in conjunction with a multi-modal generative artificial intelligence model.

### 2. Description of Related Art

Analysis of surveillance videos captured by closed-circuit television (CCTV) cameras is for detecting objects in the captured videos and determining whether a specific event has occurred using information such as the type, behavior, and number of detected objects. A technology for automatically detecting whether a defined event has occurred by analyzing videos using computer vision technology, moving away from a method in which an administrator directly monitors a plurality of videos through a monitoring device, has emerged and is being widely used.

Recently, by adopting technologies for analyzing surveillance videos based on an edge computing technology and an artificial intelligence technology, through artificial intelligence applications running on a CCTV camera or an edge device located adjacent to the camera installation location, the edge device analyzes a video and monitors for the occurrence of a defined event.

Typically, edge devices set detection conditions, that is, detection filters, to determine the occurrence of an event, and even when an object is detected, and recognize the occurrence of an event only when the detection conditions are satisfied. When false alarms occur frequently due to incorrect event occurrence determination after the detection conditions are set, it is necessary to readjust these detection conditions.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an event detection system that allows event detection conditions to be adaptively changed so that a multi-modal generative artificial intelligence model is used to verify an event detection result of an edge device and allow the occurrence of false alarms to be minimized by reflecting a result of the verification.

In one general aspect, an event detection system with adaptively changeable event detection conditions includes an edge device and a control server.

The edge device may include an event detection model unit and detect an event and transmit an event detection result including metadata related to the detected event, wherein the event detection model unit may analyze a captured video in real time and detect a defined event on the basis of set detection conditions.

The control server may verify the event detection result transmitted by the edge device through a multi-modal generative artificial intelligence model, collect statistical information on a result of the verification, and control the event detection model unit of the edge device to adjust and change the detection conditions on the basis of the statistical information.

According to another aspect of the present invention, the event detection model unit of the edge device may detect a plurality of events, and in this case, each detection condition may be set for a corresponding event.

According to still another aspect of the present invention, the edge device may include a plurality of event detection model unit, the respective event detection model units may detect different events, and each detection condition may be set for a corresponding event.

According to yet another aspect of the present invention, the edge device may analyze videos captured by a plurality of cameras in real time, the respective event detection model units may detect different events for different videos, and each detection condition may be set for a corresponding event.

When the edge device detects a plurality of events, a region of the video for detecting each event may be pre-distinguished and set for a corresponding event.

When the edge device transmits the event detection result, the metadata may include at least one of an event identifier, an image, detection region coordinates, a type of detected object, a size of the detected object, and a classification confidence of the detected object.

When the edge device transmits the event detection result, the edge device may display a region in which the event is detected on an event detection image included in the metadata and transmit the event detection image.

When the edge device detects the plurality of events simultaneously, the edge device may transmit event detection results in a form of a list at one time.

### BRIEF DESCRIPTION OF THE DRAWINGS

FIG. 1 is a diagram conceptually illustrating an event detection system according to a first aspect of the present invention.

FIG. 2 is a diagram conceptually illustrating an event detection system according to a second aspect of the present invention.

FIG. 3 is a diagram conceptually illustrating an event detection system according to a third aspect of the present invention.

FIG. 4 is a diagram conceptually illustrating an example of an event detection system according to the present invention.

Throughout the accompanying drawings and the detailed description, unless otherwise described, the same drawing reference numerals will be understood to refer to the same elements, features, and structures. The relative magnitude and depiction of these elements may be exaggerated for clarity, illustration, and convenience.

### DETAILED DESCRIPTION

The above-described and additional aspects are embodied through embodiments described with reference to the accompanying drawings. It should be understood that various combinations of elements of each embodiment are possible within embodiments unless otherwise stated or in the case of contradiction. Each block in a block diagram may in some cases represent a physical component, but in other cases it may be a logical representation of a portion of a function of a single physical component or of a function associated with a plurality of physical components. Sometimes, the entity of a block or portion thereof may be a set of program instructions. All or part of these blocks may be implemented in hardware, software, or a combination thereof.

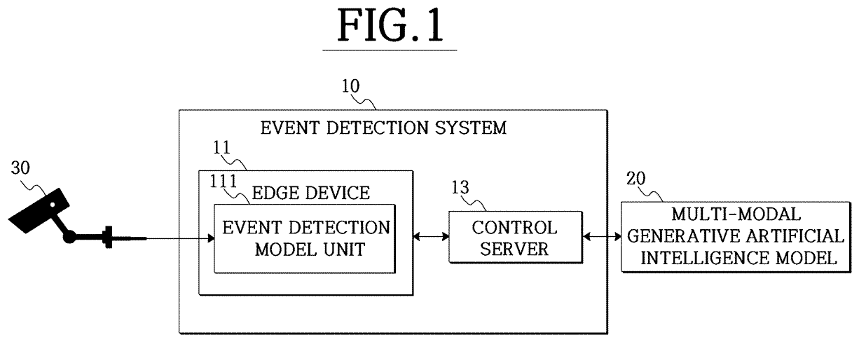

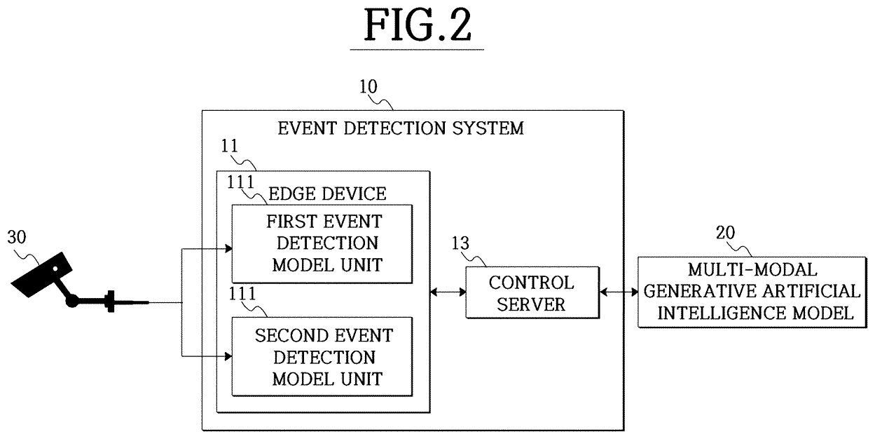

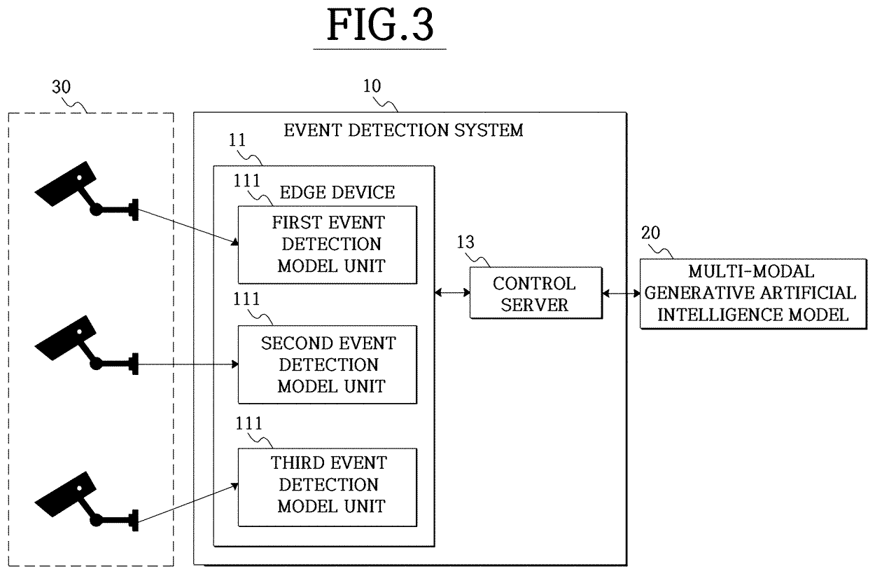

FIG. 1 is a diagram conceptually illustrating an event detection system according to a first aspect of the present invention, FIG. 2 is a diagram conceptually illustrating an event detection system according to a second aspect of the present invention, and FIG. 3 is a diagram conceptually illustrating an event detection system according to a third aspect of the present invention. An event detection system 10 with adaptively changeable event detection conditions according to an aspect of the present invention includes an edge device 11 and a control server 13.

The edge device 11 is an edge computing device and one or more cameras may be connected thereto through a network and the like. The edge device 11 is a video analysis device that analyzes videos collected from one or more cameras connected thereto in real time and generates an event (e.g., an intrusion detection security event). The edge device 11 is a device installed at each site and is called an edge box, and in general, a plurality of edge devices 11 are installed.

The edge device 11 is a computing device that analyzes videos and is a device that includes a processor and a memory which is connected to the processor and includes program instructions executable by the processor. The edge device 11 may be a computer device that further includes a storage device, a network device, an input device, etc., in addition to the processor and the memory. The processor is a processor that executes program instructions, and the memory is connected to the processor and stores the program instructions executable by the processor, data to be used by the processor for calculations, data processed by the processor, etc.

The edge device 11 includes a plurality of program modules composed of program instructions executable by the processor.

The cameras connected to the edge device 11 may be analog cameras or Internet Protocol (IP) cameras.

The edge device 11 receives and analyzes videos captured by cameras installed in a surveillance target space in real time. The edge device 11 may detect the occurrence of an event according to whether an object is detected and set detection conditions are satisfied. That is, the edge device 11 analyzes a video captured for an event set according to the surveillance purpose in real time and detects whether the corresponding event has occurred.

The edge device 11 detects an event through an event detection model unit 111 that detects a defined event on the basis of the set detection conditions.

The event detection model unit 111 may include a rule-based model, a machine learning model, a deep learning model, or a model that is a combination of two or more thereof. The event detection model unit 111 may include a discriminative artificial intelligence (AI) model or a generative AI model. An AI model unit may include a discriminative AI model or a generative AI model. The discriminative AI model is an AI model that is designed to learn from a large amount of pre-labeled data (object types, attribute information, etc.) to classify objects in new input data or extract attributes and track the objects as necessary. For example, the discriminative AI model may be used to detect objects (e.g., persons, vehicles, and trash) or extract attributes of the detected objects (e.g., color, size, location, joint positions of person, text information, etc.). Unlike a knowledge-based generative AI model, the discriminative AI model does not comprehensively understand or interpret objects or situations but rather focuses on object recognition and attribute extraction based on training data. Such a model extracts a specific object or attribute information, and event determination and detection are performed by a rule engine or additional analysis system. Therefore, the event detection model unit 111 of the present invention is a concept that includes a rule engine or the like that performs event determination and detection. The event detection model unit 111 detects an object or the object's behavior in a video and determines whether the detected object or object's behavior satisfies set detection conditions to detect whether an event has occurred. For example, the event detection model unit 111 may detect a situation in which trash is illegally dumped in a specific place in the video as an event, in this case, the event detection model unit 111 may be a model that is a combination of a deep learning model that detects an object (e.g., persons and trash) and a deep learning model that recognizes the object's behavior (e.g., throwing behavior), and the set detection conditions in this case may be for detecting both a person and trash with a confidence of 70% in the set region of the video and detecting an event regarding illegal dumping of trash when the person's throwing behavior is detected in the corresponding video.

The edge device 11 transmits an event detection result including metadata related to the detected event.

When the edge device 11 detects an event through the event detection model unit 111, the edge device 11 may verify the detected event through the control server 13 so that no false alarm is generated. Therefore, the edge device 11 transmits the event detection result including the metadata related to the detected event to the control server 13. In this case, the detected event transmitted by the edge device 11 may be transmitted in the form of an event identifier assigned to identify the event, and the metadata related to the detected event may include still images extracted from the video in which the event has been detected and include information such as the type of detected object or the like.

When the edge device 11 transmits the event detection result, the metadata may include at least any one of an event identifier, an image, detection region coordinates, the type of detected object, the size of the detected object, and a classification confidence of the detected object.

The event identifier is an ID pre-assigned to an event to distinguish detected events, the image is an image that caused the corresponding event to be detected and is a still image extracted from a video captured by a camera, the detection region coordinates are pixel coordinates within a region set to detect the corresponding event and are expressed as coordinates on the image, the type of detected object indicates the type of object that has been detected and classified (e.g., person and vehicle), the size of the detected object indicates the size of a bounding box of the corresponding object, and the confidence indicates a classification confidence score of the detected object. In addition, the metadata may further include additional information. For example, when the event detection model unit 111 detects the object's behavior, the metadata may further include the classified behavior, the classification confidence for the behavior, etc.

The control server 13 verifies the event detection results transmitted by the edge device 11 through a multi-modal generative AI model 20, collects statistical information on a result of the verification, and controls the event detection model unit 111 of the edge device 11 to adjust and change the detection conditions on the basis of the statistical information.

The control server 13 may be connected to one or more edge devices 11 through a network and receive and process event detection results from the one or more edge devices 11. The control server 13 may be a single server computer or a cloud server. The control server 13 is a device that includes a processor and a memory which is connected to the processor and includes program instructions executable by the processor. The control server 13 may further include a storage device, a network device, a display, an input device, etc., in addition to the processor and the memory. The processor is a processor that executes program instructions, and the memory is connected to the processor and stores the program instructions executable by the processor, data to be used by the processor for calculations, and data processed by the processor, etc.

The control server 13 is linked with a generative AI model, that is, a large language model (LLM), particularly, a large-scale multi-modal model (LMM) 20. The multi-modal generative AI model 20 is an LMM and is an AI model learning text descriptions of objects, behaviors, or situations and various data such as images or videos, thereby comprehensively understanding different types of data and accumulating advanced knowledge.

The control server 13 generates a prompt that allows the multi-modal generative AI model 20 to verify the event detection result transmitted by the edge device 11 and verifies the event detection result of the event detection model unit 111 through the multi-modal generative AI model 20. For example, the event detection result transmitted by the edge device 11 is an event that detects an intrusion into a set region, and as a result of analyzing the image transmitted through the prompt by the multi-modal generative AI model 20, it can be answered that the event detection result of the event detection model unit 111 is incorrect because an intrusion detection is not determined.

The control server 13 may store the event detection result of the edge device 11 and the verification result of the multi-modal generative AI model 20 and generate statistical information. The control server 13 may analyze the statistical information to determine the necessity of changing the detection conditions of the event detection model unit 111 of the edge device 11. For example, the control server 13 may analyze the event detection result of the edge device 11 and the event detection result (statistical information of the verification results) of the multi-modal generative AI model 20, and in the case in which when the size of the object is less than or equal to 20×60 in width, the event detection result of the edge device 11 and the event detection result of the multi-modal generative AI model 20 are different and when the size of the object is greater than 20×60 in width, the event detection result of the edge device 11 and the event detection result of the multi-modal generative AI model 20 are the same, the control server 13 may add the case to the detection conditions of the event detection model unit 111 or change the detection conditions, so that an event is detected when the size of the detected object is greater than 20×60. That is, the control server 13 controls the event detection model unit 111 of the edge device 11 to adjust and change the detection conditions on the basis of the statistical information.

According to another aspect of the present invention, the event detection model unit 111 of the edge device 11 may detect a plurality of events.

The event detection model unit 111 of this aspect may set a region for detecting events for an image into a plurality of regions and attempt to detect events for each region. In this case, detection conditions are set for each event. In FIG. 2, the event detection system 10 of this aspect is conceptually illustrated.

The edge device 11 may pre-distinguish and set a region of a video for detecting each event for each event.

For example, a detection condition may be set so that the event detection model unit 111 detects a human intrusion in a first region set at a lower left end of the image, and a detection condition may be set so that the event detection model unit 111 detects an animal intrusion in a second region set at an upper right end of the image.

In this aspect, a single event detection model unit 111 may detect a plurality of events.

According to another aspect of the present invention, the edge device 11 may include a plurality of event detection model units 111.

In this case, the respective event detection model unit 111 detect different events for the same video. In this case, detection conditions are set for each event.

For example, a detection condition may be set so that a first event detection model unit 111 detects a human intrusion in a first region set at a lower left end of the image, and a detection condition may be set so that a second event detection model unit 111 detects an animal intrusion in a second region set at an upper right end of the image.

According to still another aspect of the present invention, the edge device 11 may analyze videos captured by a plurality of cameras in real time. In this case, the edge device 11 may also include a plurality of event detection model units 111 that detect events in the videos.

In this case, the respective event detection model units 111 detect different events for different videos, and each detection condition is set for a corresponding event. In FIG. 3, the event detection system 10 of this aspect is conceptually illustrated.

For example, a first event detection model unit 111 may detect an event according to a detection condition set to detect a human intrusion in a first region set in a first still image extracted from a video captured by a first camera, and the second event detection model unit 111 may detect an event according to a detection condition set to detect an animal intrusion in a second region set in a second still image extracted from a video captured by a second camera.

However, the present invention is not limited thereto, and some event detection model units 111 may detect different events for the same video.

For example, a first event detection model unit 111 may detect an event according to a detection condition set to detect a human intrusion in a first region set in a first still image extracted from a video captured by a first camera, a second event detection model unit 111 may detect an event according to a detection condition set to detect an animal intrusion in a second region set in a second still image extracted from the video captured by a second camera, and a third event detection model unit 111 may detect an event according to a detection condition set to detect an animal intrusion in a third region set in a third still image extracted from a video captured by a third camera.

When the edge device 11 transmits the event detection result to the control server 13, the edge device 11 may display a region in which the event is detected on an event detection image included in metadata and transmit the event detection image.

That is, the edge device 11 displays a region in which the corresponding model is set to detect an event on an image used by the event detection model unit 111 when detecting an event, so as to be distinguished from other regions, and transmits this image to the control server 13. For example, when the coordinates of the set detection region range from (0, 0) to (250, 250), the edge device 11 may display the detection region with a red solid line.

When the edge device 11 detects a plurality of events for one image, the edge device 11 may display each region on the image to be distinguished from other regions, and when the edge device 11 detects events for a plurality of images, the edge device 11 may display the event detection region for each image. Additionally, the edge device 11 may display the region on the image and then display a label such as “Zone 1.”

The edge device 11 may detect a plurality of events simultaneously through one or more event detection model units 111. In this case, the event detection result transmitted from the edge device 11 to the control server 13 includes a plurality of detected detection results. In this case, the edge device 11 may transmit the event detection results at one time in the form of a list. For example, when the edge device 11 detects three events, the edge device 11 may generate a first event detection result (Event 1, Region Coordinate 1, Person, Size 1, and Classification Confidence 1), a second event detection result (Event 2, Region Coordinate 2, Dog, Size 2, and Classification Confidence 2), and a third event detection result (Event 3, Region Coordinate 3, Person, Size 3, and Classification Confidence 3) in the form of a list, and transmit the list.

According to some aspects of the present invention, the edge device 11 and the control server 13 may be included in a single device, that is, a single computing device. When the processing power of the edge device 11 is sufficient and the number of events to be simultaneously detected is not large, software implementing the control server 13 on the edge device 11 may be executed.

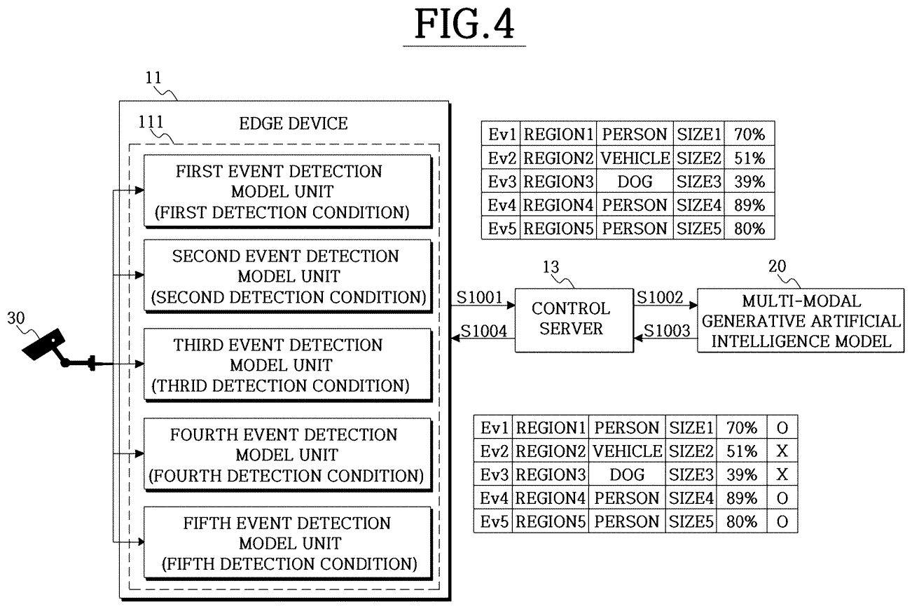

FIG. 4 is a diagram conceptually illustrating an example of an event detection system according to the present invention. An edge device 11 illustrated in FIG. 4 is illustrated as including five event detection model units 111, it is assumed that the respective event detection model units 111 detect different events Ev1, Ev2, Ev3, Ev4, and Ev5 from videos captured by the same camera, and an example in which the respective event detection model units 111 detect events according to Detection Condition 1, Detection Condition 2, Detection Condition 3, Detection Condition 4, And Detection Condition 5, respectively is illustrated.

The edge device 11 transmits event detection results of the events detected by the respective event detection model units 111 according to the respective detection conditions in the form of a list (expressed in a table format for convenience) (S1001).

A control server 13 uses the event detection results received from the edge device 11 to verify the event detection results through a multi-modal generative AI model 20 using a prompt that allows the multi-modal generative AI model 20 to request to verify the event detection results (S1002 and S1003). A result of the verification is indicated as O when the result of the verification is correct and indicated as X when the result of the verification is incorrect, and such information is stored for statistical information collection.

The control server 13 determines the event detection model units 111 that require a change in detection conditions and the changed detection conditions, on the basis of the stored statistical information. The control server 13 transmits the changed detection conditions to the edge device 11 (S1004) so that the edge device 11 changes the corresponding detection conditions.

Therefore, according to the present invention, even when initial detection conditions are set after the event detection system 10 is installed, the detection conditions may be adaptively changed according to the accuracy of the event detection results of the edge device 11 according to current detection conditions.

According to the present invention, a multi-modal generative AI model can be used to verify event detection results of an edge device, and the event detection conditions can be adaptively changed to allow the occurrence of false alarms to be minimized by reflecting a result of the verification.

While exemplary embodiments of the present invention have been described with reference to accompanying drawing, the present invention is not limited to the exemplary embodiments. It should be interpreted that various modifications that can be apparently made by those skilled in the art are included in the scope of the present invention. The scope of the patent claims is intended to encompass these variations. The claims of the present invention are intended to encompass these variations.

1. A event detection system with adaptively changeable event detection conditions, comprising:
an edge device including an event detection model unit and configured to detect an event and transmit an event detection result including metadata related to the detected event, wherein the event detection model unit analyzes a captured video in real time and detects a defined event on the basis of set detection conditions; and
a control server configured to verify the event detection result transmitted by the edge device through a multi-modal generative artificial intelligence model, collect statistical information on a result of the verification, and control the event detection model unit of the edge device to adjust and change the detection conditions on the basis of the statistical information.

2. The event detection system of claim 1, wherein the event detection model unit of the edge device detects a plurality of events, and each detection condition is set for a corresponding event.

3. The event detection system of claim 1, wherein the edge device includes a plurality of event detection model units, the respective event detection model units detect different events, and each detection condition is set for a corresponding event.

4. The event detection system of claim 3, wherein the edge device analyzes videos captured by a plurality of cameras in real time, the respective event detection model units detect different events for different videos, and each detection condition is set for a corresponding event.

5. The event detection system of claim 2, wherein a region of the video for detecting each event is pre-distinguished and set for a corresponding event.

6. The event detection system of claim 1, wherein, when the edge device transmits the event detection result, the metadata includes at least one of an event identifier, an image, detection region coordinates, a type of detected object, a size of the detected object, and a classification confidence of the detected object.

7. The event detection system of claim 6, wherein, when the edge device transmits the event detection result, the edge device displays a region in which the event is detected on an event detection image included in the metadata and transmits the event detection image.

8. The event detection system of claim 2, wherein, when the edge device detects the plurality of events simultaneously, the edge device transmits event detection results in a form of a list at one time.

9. The event detection system of claim 1, wherein the edge device and the control server are included in a single device.
